(19) United States
(12) Patent Application Publication
(10) Pub. No.: US 2009/0061710 A1
(43) Pub. Date: Mar. 5, 2009

(54) Gas Diffusion Layer, System, and Method for Manufacturing a Gas Diffusion Layer

(75) Inventors: Axel Helmbold, Weinheim (DE); Karim Salama, Weinheim (DE); Denis Reibel, Herrlisheim (FR); Klaus-Dietmar Wagner, Heddesheim (DE); Achim Bock, Weinheim (DE); Silke Wagener, Darmstadt (DE)

Correspondence Address: Davidson, Davidson & Kappel, LLC, 485 7th Avenue, 14th Floor, New York, NY, 10018, US

(73) Assignee: Carl Freudenberg KG, Weinheim (DE)

(21) Appl. No.: 11/887,171

(22) PCT Filed: Mar. 31, 2006
(86) PCT No.: PCT/EP2006/002927

§ 371 Date: Sep. 26, 2007

(30) Foreign Application Priority Data
May 11, 2005 (DE) 10 2005 022 484.9

(51) Int. Cl. B32B 5/22; B32B 5/24; D01F 9/14

(52) U.S. Cl. 442/181; 428/304.4; 442/304; 442/327; 264/29.2

(57) ABSTRACT

A gas diffusion layer, including at least two functional areas (2a, 2b) which are operationally linked to one another, the first area (2a) having a porous structure and the second area (2b) being designed as a stabilization zone, achieves the object of providing a system which implements problem-free operation of a fuel cell while optimizing its efficiency. A system which includes two gas diffusion layers and a method for manufacturing the gas diffusion layer achieve the further cited objects.

This application is a national phase of International Application No. PCT/EP2006/002927, filed Mar. 31, 2006, which claims priority to DE 10 2005 022 484.9, filed May 11, 2005.

### FIELD OF THE INVENTION

The present invention relates to a gas diffusion layer. Furthermore, the present invention relates to a system including two gas diffusion layers. Finally, the present invention relates to a method for producing a gas diffusion layer.

### BACKGROUND

Gas diffusion layers are used in fuel cells. The conventional structure of a fuel cell is distinguished by a layer sequence of a bipolar plate having a gas distributor structure, a gas diffusion layer, and a reaction layer. These layers are compressed to minimize contact resistances. To achieve a homogeneous compression uninfluenced by thickness tolerances, the highest possible elasticity of the gas diffusion layer is desirable.

Elastic gas diffusion layers penetrate into the gas channels of a fuel cell, however. The channel depths are very small and relatively wide in gas distributors of fuel cells in the automobile industry. The channel depth is less than 400 μm, and the channel width is greater than 1000 μm. This dimensioning is necessary to meet the requirements for the fuel cells.

The pressure drop within a line is not linear, but rather is proportional to the inverse of the fourth power of the radius of a line. Therefore, even a slight penetration of the gas diffusion layer into the channels results in a significant pressure drop in the cell. A reduction of their efficiency because of parasitic losses in the compressor results therefrom.

Simultaneously, the contact pressure of the gas diffusion layer on the reaction layer or a diaphragm in the area of the channel is low. An increased contact resistance thus results in this area, which additionally reduces the efficiency of the cell.

In the case of pressure differences between the anode and the cathode of the fuel cell, sagging of the gas diffusion layer is also a concern. For such applications, carbon fiber papers having a very high tensile modulus are almost exclusively used. However, these papers may no longer be rolled up beyond a specific thickness and may therefore also not be manufactured or processed continuously.

The gas diffusion layers known from the related art therefore have disadvantages in many regards.

### SUMMARY OF THE INVENTION

In accordance with an embodiment of the present invention, a gas diffusion layer (2) includes at least two functional areas (2a, 2b) which are operationally linked to one another, the first area (2a) having a porous structure and the second area (2b) being designed as a stabilization zone.

### BRIEF DESCRIPTION OF THE DRAWING

The present invention is described in greater detail on the basis of the drawing, in which:

FIG. 1 shows a system in a fuel cell, which includes a gas diffusion layer having a porous structure and a stabilization zone.

### DETAILED DESCRIPTION OF THE INVENTION

The present invention is based on an object of providing a system which implements problem-free operation of a fuel cell while optimizing its efficiency.

Accordingly, a gas diffusion layer includes at least two functional areas which are linked to one another, the first area having a porous structure and the second area being designed as a stabilization zone.

It has first been recognized according to the present invention that a gas diffusion layer must have various functional areas to deploy its effect optimally. In a second step, it has been recognized that the precaution of a stabilization zone prevents the first area from being pressed into the gas channels of a fuel cell during compression of the gas diffusion layer. In a refined manner, it is ensured that sufficient pressure may be applied to the gas diffusion layer to reduce the contact resistance of the gas diffusion layer. Furthermore, it is ensured that the gas diffusion layer does not press into the gas channels. The constructive design of the gas diffusion layer according to the present invention therefore optimizes the efficiency of a fuel cell and ensures its problem-free operation. As a result, an object of the present invention as cited at the beginning is achieved.

The first area may particularly advantageously have a higher compressibility than the second area. This concrete design ensures that the first area is compressible without problems, but the second area has increased stability. This increased stability ensures that the second area does not press into cavities which adjoin it.

The first area may be implemented to be more elastic than the second area. This concrete design allows a compensation for irregularities or structures which are pressed against the first area. The first area may thus implement a particular tightness.

The first area may have a lower tensile modulus than the second area. This design ensures that the first area rather than the second area sags. The gas diffusion layer may be characterized in its entirety by a bending modulus of less than 1 GPa. A gas diffusion layer which has such a bending modulus is capable of being rolled up without problems. This allows continuous manufacture of the gas diffusion layer, because it may be wound onto rolls without breaking.

The areas may be implemented as plies or planar layers. In this concrete design, prefinished and differently treated layers may be bonded to one another without problems. It is thus possible to parameterize the particular layers differently and separately from one another.

The areas may be designed as nonwoven materials, woven fabrics, knitted fabrics, lattices, or mesh. The use of these materials provides the gas diffusion layer with a special stability. Furthermore, these materials are commercially widely available, so that manufacturing the gas diffusion layer may be implemented without any problems.

The first area may be implemented as a nonwoven material including carbon fibers. The first area may be designed as a porous nonwoven material including carbon fibers or carbon objects. The first area may be implemented as a woven fabric, knitted fabric, lattice, or mesh. The use of carbon fibers provides the first area with a special electrical conductivity.

The nonwoven material may include up to 30% by weight binder fibers and have a mass per unit area of 30 g/m² to 300 g/m². The use of up to 30% by weight binder fibers ensures that the desired functional physical and chemical properties of the particular area are not excessively influenced. The selected mass per unit area allows mechanical solidification of the nonwoven material. The nonwoven material may be mechanically solidified by high-pressure fluid jets at pressures of 100 bar to 300 bar.

The nonwoven material may be solidified by fluid jets and compacted by calendering. These measures particularly increase the stability of the nonwoven material in particular. Furthermore, it is possible to emboss structures on or dimension the nonwoven material by calendering.

The nonwoven material may be carbonized at 800° C. to 2500° C. The carbonization of the nonwoven material ensures further solidification. Furthermore, the electrical conductivity of the nonwoven material may be increased by carbonization.

The second area may include a wet-laid nonwoven material. This area may be electrically conductive. It is used in particular for stabilizing the entire gas diffusion layer and does not have to assume further tasks. This area may include carbon fibers. The second area may be implemented as electrically conductive by using carbon fibers.

The second area may be implemented as a coating. The precaution of a coating allows a particularly thin design of the second area. A particularly compact structure of the entire gas diffusion layer may thus be implemented.

The coating may include a binder capable of carbonization. The use of a binder capable of carbonization allows stabilization of the gas diffusion layer.

The coating may have a mass per unit area of 1 g/m² to 100 g/m². The selection of the mass per unit area from this range ensures sufficient stability of the gas diffusion layer. In particular, it is ensured that the gas diffusion layer may be rolled up problem-free without breaking. The coating may include resins and/or thermoplastic materials. The selection of these materials ensures processability without any problems, because they form a composite with most common fiber materials. In particular, it is possible to apply the coating so thinly that at most 10% of the surface of the first area is covered. Pitches or tars made of coal tar, petroleum, wood, or mixtures thereof, phenol resins, furan resins, epoxy resins, polystyrenes, polyacrylates, acrylonitrile butadiene, styrene terpolymers, melamine resins, phenol novolacs having hexamethylene tetramine, phenol-epoxide resin pre-condensates, copolymers, modified polymers, or mixtures of the listed compounds may be used as the binder which may be carbonized. Saccharides, e.g., monosaccharides such as table sugar, are also suitable for this purpose. All of these binders are distinguished by a particularly suitable processability. Binders which may not be carbonized may also be used. For example, polytetrafluoroethylene, which is distinguished by particularly hydrophobic properties, may be used.

The second area may have polyvinyl alcohols, carbon blacks, graphites, metals, carbon fibers, or metal fibers. These admixtures may be admixed with a second area which is designed as a coating. The use of polyvinyl alcohols allows the adjustment of the porosity of the second area. Admixing carbon black, graphite, or metal allows the electrical conductivity of the second area to be increased. The strength may be increased by admixing carbon fibers or metal fibers.

The gas diffusion layer may have a progressive structure. A progressive structure may be described by gradients. In particular, the gas diffusion layer may be made of a uniform material, which may be characterized in regard to its bending resistance, its tensile modulus, or other mechanical properties by gradients in various spatial directions. On this basis, the compressibility decreases continuously from the first area in the direction of the second area, for example. Such a continuous reduction is conceivable in regard to all mechanical properties in all spatial directions. The gas diffusion layer is thus adaptable to predefined spatial conditions.

An embodiment of the present invention provides a system which includes two gas diffusion layers, the gas diffusion layers being oriented having their first areas facing toward one another and their second areas facing away from one another.

The system according to the present invention is distinguished in particular in that the bending modulus of such a pair is at least 25% higher than if the second areas were positioned facing toward one another.

Entirely as a function of the requirements for a fuel cell in which the gas diffusion layers of the present invention are used, it is also conceivable to provide a system in which the second areas of two gas diffusion layers are positioned facing toward one another.

Furthermore, an embodiment of the present invention provides a method for manufacturing a previously described gas diffusion layer having a second area (2b) which is designed as a stabilization zone is assigned to a first area (2a) having a porous structure.

The areas (2a and 2b) may advantageously be jointly carbonized or graphitized. This design allows a particularly homogeneous structure of the entire gas diffusion layer. In particular, due to this method step, the two areas have passed through an identical manufacturing history, which unifies their material properties.

The areas (2a and 2b) may be pressed together at a contact pressure of 0.1 MPa to 40 MPa and a temperature of 20° C. to 400° C. This method step is conceivable with the use of suitable binders. The use of binders ensures a solid bond of the two areas. Furthermore, this method step may include a lamination step under defined pressure and temperature conditions. The lamination step allows selective application of pressure to the gas diffusion layer. Furthermore, structures may be embossed on the gas diffusion layer.

The first area may be subjected to solidification. The first area may be subjected to a mechanical solidification. On this basis, a first area implemented as a fibrous web may be solidified by high-pressure fluid jets. The fibers are swirled and intertwined with one another during the treatment with high-pressure fluid jets. A part of the fibers have an orientation in the Z direction after this treatment, namely in the direction of the thickness of the nonwoven material. The solidified nonwoven material is optionally compacted by mechanical compaction to 30% to 90% of its starting thickness.

The first area may be subjected to a step-by-step thermal treatment, first at a temperature of up to 1500° C. and then up to 2500° C. This method step allows the carbonization or graphitization of the first area in multiple steps.

All method steps may be repeated multiple times and performed in an arbitrary sequence if technically advisable.

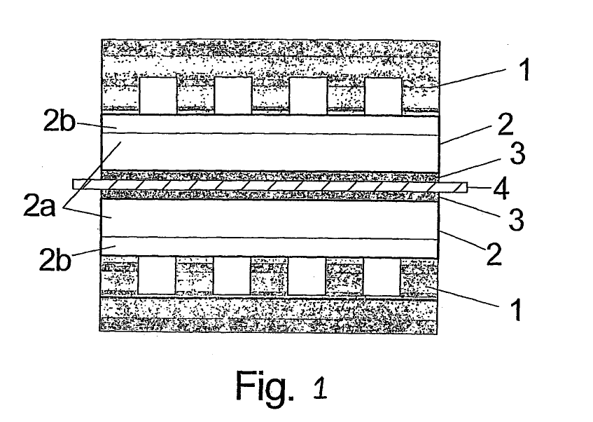

FIG. 1 shows a system inside a fuel cell. A gas diffusion layer 2 is situated between a gas distributor 1. Gas diffusion layer 2 includes two functional areas 2a and 2b, which are operationally linked to one another. First area 2a is designed as a porous structure. Second area 2b is designed as a stabilization zone. An electrode 3, which is connected to a diaphragm 4, adjoins gas diffusion layer 2. The structure of the system is symmetrical in relation to diaphragm 4.

In the following, two examples of possible embodiments of such a gas diffusion layer are specified:

### EXAMPLE 1

A two-layered gas diffusion layer is produced as follows:

First, the first layer is manufactured in such a way that curled, oxidized polyacrylonitrile fibers are carded and laid to form a web. This web is then swirled and solidified by high-pressure fluid water jets at a pressure of 150 bar. This layer is then dried at 120° C. The first layer is then compressed to a 0.2 mm thickness at a temperature of 320° C. using a calender. The first layer is then carbonized at a temperature of 1400° C. under nitrogen atmosphere. The first layer thus manufactured has a mass per unit area of 65 g/m².

The second layer is represented by a carbon fiber paper which is commercially available. This carbon fiber paper is manufactured under the name TGPH 30 by Toray Industries Inc., Japan. The two layers are laid one on top of another and compressed during installation in a fuel cell. The first layer faces toward the diaphragm of a fuel cell.

### EXAMPLE 2

Example 2 represents a gas diffusion layer in which the first layer is manufactured similarly to the first layer from Example 1. The first layer differs solely in its mass per unit area from the layer of Example 1.

The mass per unit area of the first layer according to Example 2 is 100 g/m². A coating functions as the second layer. The coating has a mass per unit area of 25 g/m² and includes 80% carbon black and 20% phenyl resin (type 9282 FP, Bakelite, Germany). The coating is punctual, the points having a diameter which is less than 0.5 mm. The coating causes 27% single-side area coverage of the first layer. The coating is applied to the first layer using screen printing. A paste which includes 20% solid, namely carbon black and phenyl resin, and 80% water is used for the screen printing. After the application of the paste by screen printing, it is dried at a temperature of 120° C., which causes the water component to vaporize. A controlled heating at a temperature of 200° C. results in complete reaction of the phenol resin. Following these manufacturing steps, the composite is carbonized under nitrogen atmosphere at 1400° C.

It is particularly emphasized that the previous exemplary embodiments, which were selected purely arbitrarily, are solely used to explain the teaching of the present invention, but not to restrict it to these exemplary embodiments.

1-25. (canceled)

26: A gas diffusion layer comprising: a first functional area and a second functional area operationally linked to the first area, the first area having a porous structure and the second area being designed as a stabilization zone.

27: The gas diffusion layer as recited in claim 26, wherein the first area has a higher compressibility than the second area.

28: The gas diffusion layer as recited in claim 26, wherein the first area is more elastic than the second area.

29: The gas diffusion layer as recited in claim 26, wherein the first area has a lower tensile modulus than the second area.

30: The gas diffusion layer as recited in claim 26, wherein the layer has a bending modulus of less than 1 GPa.

31: The gas diffusion layer as recited in claim 26, wherein the first and second areas are implemented as plies or planar layers.

32: The gas diffusion layer as recited in claim 26, wherein the first and second areas are designed as nonwoven materials, woven fabrics, knitted fabrics, lattices, or mesh.

33: The gas diffusion layer as recited in claim 26, wherein the first area is implemented as a nonwoven material including carbon fibers.

34: The gas diffusion layer as recited in claim 33, wherein the nonwoven material includes up to 30% by weight binder fibers and has a mass per unit area of 30 g/m² to 300 g/m².

35: The gas diffusion layer as recited in claim 33, wherein the nonwoven material is solidified by fluid jets and compacted by calendering.

36: The gas diffusion layer as recited in claim 33, wherein the nonwoven material is carbonized at 800° C. to 2500° C.

37: The gas diffusion layer as recited in claim 26, wherein the second area includes a wet-laid nonwoven material.

38: The gas diffusion layer as recited in claim 26, wherein the second area is designed as a coating.

39: The gas diffusion layer as recited in claim 38, wherein the coating includes a binder capable of carbonization.

40: The gas diffusion layer as recited in claim 38, wherein the coating has a mass per unit area of 1 g/m² to 100 g/m².

41: The gas diffusion layer as recited in claim 38, wherein the coating includes resins and/or thermoplastic materials.

42: The gas diffusion layer as recited in claim 38, wherein the second area has polyvinyl alcohols, carbon blacks, graphites, metals, carbon fibers, or metal fibers.

43: The gas diffusion layer as recited in claim 26, wherein the layer has a progressive structure.

44: A system comprising two gas diffusion layers as recited in claim 26, the gas diffusion layers being oriented having respective first areas facing toward one another and respective second areas facing away from one another.

45: The method for manufacturing a gas diffusion layer as recited in claim 26.

46: The method as recited in claim 45, wherein the areas are jointly carbonized or graphitized.

47: The method as recited in claim 45, wherein the first and second areas are pressed together at a contact pressure of 0.1 MPa to 40 MPa and at a temperature of 20° C. to 400° C.

48: The method as recited in claim 45, wherein the first area is subjected to a solidification.

49: The method as recited in claim 45, wherein at least one first area is subjected to a step-by-step thermal treatment at temperatures up to 2500° C.

50: The method as recited in claim 45, wherein a plurality of layers are manufactured.
